(19) United States
(12) Patent Application Publication
(10) Pub. No.: US 2017/0332840 A1
(43) Pub. Date: Nov. 23, 2017

(54) Cooktop Insert

(71) Applicant: Michiel Schuitemaker, Miami Beach, FL (US)

(72) Inventor: Michiel Schuitemaker, Miami Beach, FL (US)

(73) Assignee: Leopard Industries, Inc., Cincinnati, OH (US)

(21) Appl. No.: 15/159,065

(22) Filed: May 19, 2016

(51) Int. Cl. A47J 37/07

(52) U.S. Cl. CPC A47J 37/0786

(57) ABSTRACT

An outdoor cooktop apparatus intended to be used with a standard barbeque grill or firepit comprising a plate having an aperture. The plate defines a top surface for cooking food, and a bottom that may be supported by the grill or firepit over combustible material. The top surface is a continuous surface so that food being cooked is not in direct contact with fire.

### FIELD OF THE INVENTION

This invention relates to a cooking apparatus for outdoor cooking. It is particularly directed to an apparatus that may be used with an outdoor grill, barbeque, or fire pit. Background

Barbequing on outdoor grills is an extremely popular activity practiced by many, especially during the summer months. Typical barbeque grill fare includes burgers, hot dogs, chicken, fish, and vegetables. The very nature of the grilling apparatus, however, has certain drawbacks.

For example, certain foods are not easily prepared on a standard grill top. These include foods that, when uncooked, are in substantially liquid form, such as batter based foods and eggs. Still other foods are difficult to use with standard grill tops due to their size, such as certain smaller vegetables. Some fish is also difficult to prepare on a standard grill top due to its tendency to break apart during cooking. Another shortcoming of such cooking devices is the risk of flare ups from grease dripping from cooking meats. Such flare ups create the risk of burning the food, as well as the cook, or others around the device. In addition to the immediate dangers of flare ups, there has been some research associating the cooking of meat over a flame and an increased exposure to cancer-causing carcinogens known as PAHs and HCAs. While other forms of high-heat cooking may also create PAHs and HCAs, they are more often caused by a combination of smoke and direct flame contact with the food. As such reducing or eliminating flare ups is desirable.

When cooking such foods, it becomes necessary to use, for example, aluminum foil placed on the cooking surface of the grill. However, cooking on aluminum foil has drawbacks. The drawbacks of cooking on aluminum foil include its relative flimsiness in addition to possible health concerns associated with aluminum. Another alternative is to use a pot or a pan on the grill.

Still another option is to place a conventional griddle on top of the grill grates. Griddles used on grill grates typically include a rimmed periphery. Such a rim allows grease to pool on the griddle, which is undesirable.

Another apparatus that exists is a baking steel. These baking steels are essentially a flat, relatively heavy gauge sheet of steel that is placed on the grill grates. Grease from cooking foods may fall over the edge of the baking steels onto the heating source, and thus causing dangerous flare-ups between the cook and the food.

Thus, it would be advantageous to be able to cook any food on a grill or barbeque without using aluminum foil or conventional griddle or baking steel.

### SUMMARY OF THE INVENTION

The present invention is directed to a cooktop insert for outdoor cooking apparatuses, such as grills and firepits.

The cooktop apparatus, which is adapted to be mounted with a grill or firepit device, includes a generally planar plate defining a top surface and a bottom. In a preferred embodiment, the plate is made of a relatively heavy metal that has good heat retention, such as cast iron or steel. However, other materials, such as aluminum or ceramics can be used. The top surface should be food-safe. The bottom of the plate is adapted to engage an upper portion of the grill or firepit such that the bottom is positioned above a heat source in the grill or firepit device. In some embodiments, the bottom may be entirely flat. In others, the bottom may include a raised annular section to set within the rim of a round grill. In still other embodiments, the bottom may be adapted to mate with brackets that normally hold the grill grates of the barbeque. With a round grill or firepit, it is preferred that the plate be generally disc shaped.

The plate further defines at least one interior aperture, which is preferably centrally located and circular in shape. This aperture allows for grease from cooking foods to be moved away from the food and into the fire without risk of exposing the food or the cook to flare-ups.

The plate may further include anchors for attaching grilling accessories. For example, brackets for holding skewers over the aperture may be included. A roasting spit could also be attached. Other accessories, such as a basket placed within the aperture to allow direct contact with the fire can also be used.

In some embodiments, the cooktop apparatus may include one or more handles secured to the plate. Preferably, the handle or handles will include a heat-insulated portion for safety.

The top surface of the cooktop apparatus is preferably smooth and continuous. In a highly preferred embodiment, the top surface defines a slope extending downward towards the at least one aperture. This allows any grease to be urged towards and through the aperture by gravity. The sloping of the top surface is explained in greater detail in application Ser. No. 15/080,005 filed on Mar. 24, 2016, the teachings of which are incorporated herein by reference.

There has thus been outlined, rather broadly, the more important features of the invention in order that the detailed description thereof that follows may be better understood, and in order that the present contribution to the art may be better appreciated. There are, of course, additional features of the invention that will be described hereinafter, and which may form the subject matter of the claims appended hereto. Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

There is shown in the drawings presently preferred embodiments of the present invention.

FIG. 1 is perspective view of a preferred embodiment of the present invention;

FIG. 2 is a bottom view of the preferred embodiment of FIG. 1;

FIG. 3 is an exploded view of present invention of FIG. 1 with a grill to depict its intended use;

FIG. 4A is another alternative embodiment of the present invention with optional anchors for accessories and detachable handles;

FIG. 4B is another alternative embodiment of the present invention with optional anchors for accessories and fixed handles;

FIG. 5 is an alternative embodiment of the present invention; and

FIG. 6 is an embodiment of an exemplary gas grill.

It should be noted that the drawings of the invention are not to scale. The drawings are merely schematic representations, not intended to portray specific parameters of the invention. The drawings are intended to depict only typical embodiments of the invention, and therefore should not be considered as limiting the scope of the invention. The invention will be described with additional specificity and detail through the use of the accompanying drawings. In the drawings like numbering represents like elements between the drawings.

### DETAILED DESCRIPTION OF THE PREFERRED EMBODIMENTS

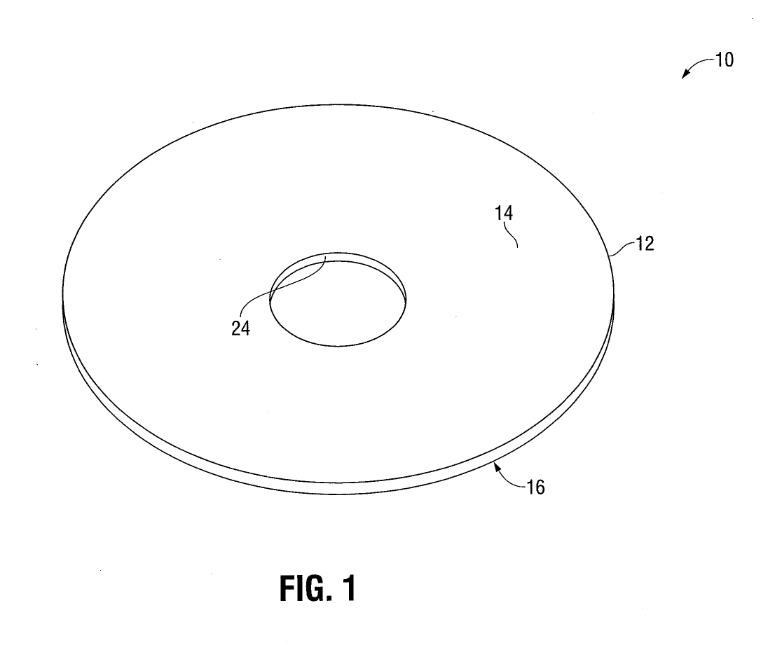

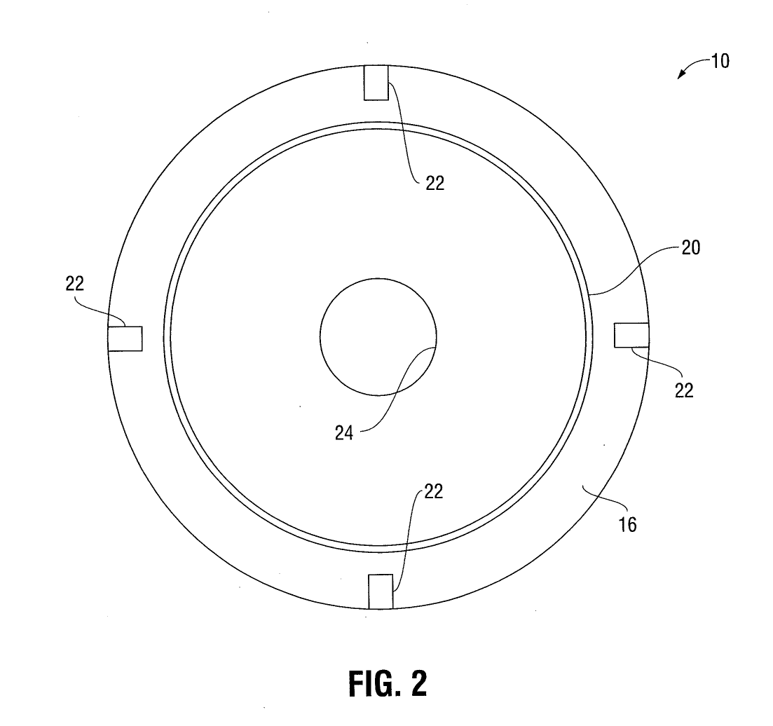

There is shown in FIGS. 1 and 2 of the drawings a preferred embodiment of the present invention. The cooktop apparatus 10 comprises a plate 12, preferably made of a relatively heavy metal, such as cast iron or steel. The plate 12 defines a top surface 14 and a bottom 16. The top surface 14 is preferably smooth and continuous. The top surface 14 is of a food safe material. Although not shown, in some embodiments, the top surface may include a coating adapted to prevent sticking of food. As shown in this embodiment, the top surface 14 is continuous and uninterrupted, yet in some embodiments, the top surface 14 may include portions with texturing so as to provide “grill marks” on the food during cooking. The plate 12 further defines an aperture 24, which in this preferred embodiment is centrally formed and circular in shape.

Referring to FIG. 2, the bottom 16 of the cooktop apparatus 10 may include different formations to better allow mounting with a grill or firepit. One formation is an annular ridge 20 formed with the bottom surface 18. In some embodiments, this annular ridge 20 may be formed to nest within the rim of a firepit or grill kettle. Another formation is a set of notches 22 which are configured to mate with the grill grate brackets of a grill. It should be understood that while the figure includes several examples of formations, none or only some of them may be included.

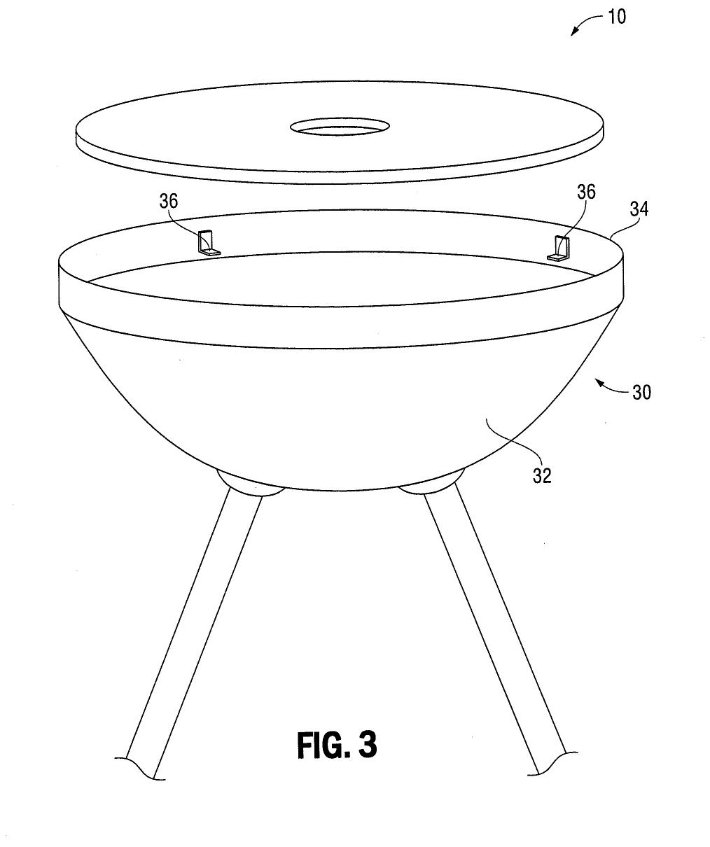

An intended use of the cooktop apparatus 10 is shown with respect to FIG. 3. In this example, the cooktop apparatus 10 is configured to be used with kettle grill 30. Grill 30 includes a kettle 32 defining a rim 34. Formed below the rim 34 are a plurality of brackets 36, which are normally configured to support a grill grate. The apparatus 10 is configured to fit within the rim 34 of the kettle 32. Although not shown, the cooktop apparatus may alternatively be placed to sit on top of the rim 34.

Preferably, the combustible material for the heating source, such as charcoal, is first ignited, and then the cooking apparatus mounted with the kettle grill 30. However, additional combustible material can be added through the aperture. The aperture also allows a cook to manipulate the combustible material under the cooktop apparatus 10 without needing to remove the apparatus or grill plates, and also avoids charcoal ash from getting on the food. Similarly, because food is not exposed directly to the ignited combustible material as it would be with a grill grate, the dangers from flare ups is minimized or eliminated.

Also, because of the continuous surface, smaller food items or foods that would ordinarily fall through grill grates can be cooked. Any grease or oil from the food may be moved through the aperture. While such grease or oil may cause flare up when it contacts the fire, the flare up will not contact the food and will be directed away from the cook.

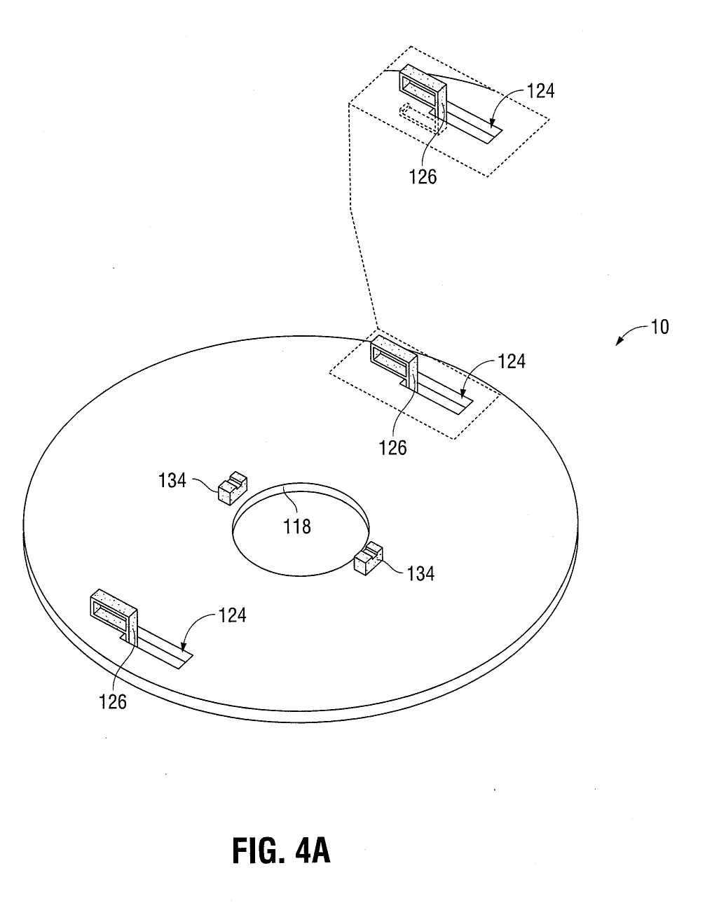

A variety of optional features are depicted in FIG. 4A. In this embodiment, cooktop apparatus 110 again comprises a plate 112 defining a top surface 114, a bottom 116, and an aperture 118. In some embodiments, a plurality of holes or slots 124 may be formed in the plate to enable a detachable handle 126 to be engaged with the plate to lift the cooktop apparatus. These handles include heat resistant portions 122. Formed about the aperture is a plurality of anchors 134. These anchors can be used to secure skewers or a rotating spit (not shown). As an alternative to handles being detachable from the plate, as shown in FIG. 4B, the plate 112 may have secured therewith handles 120.

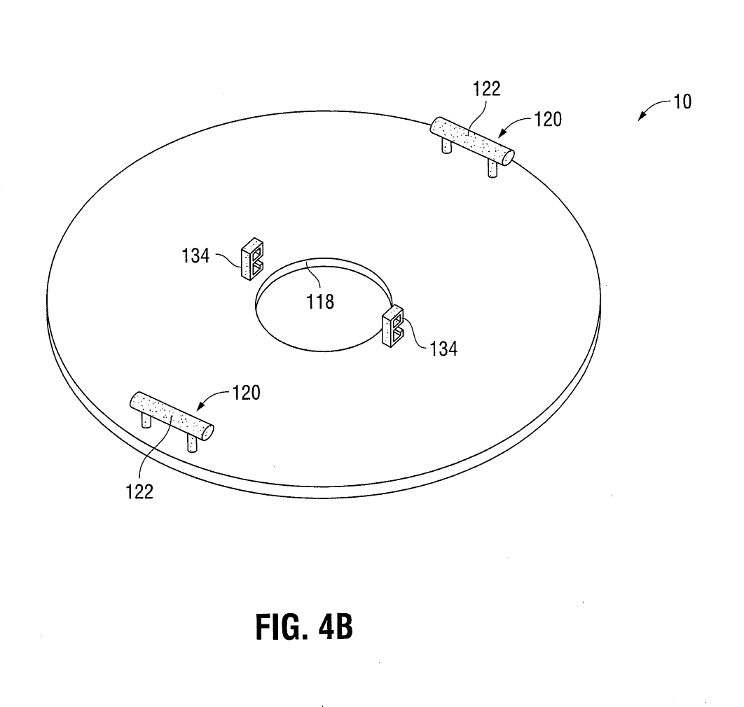

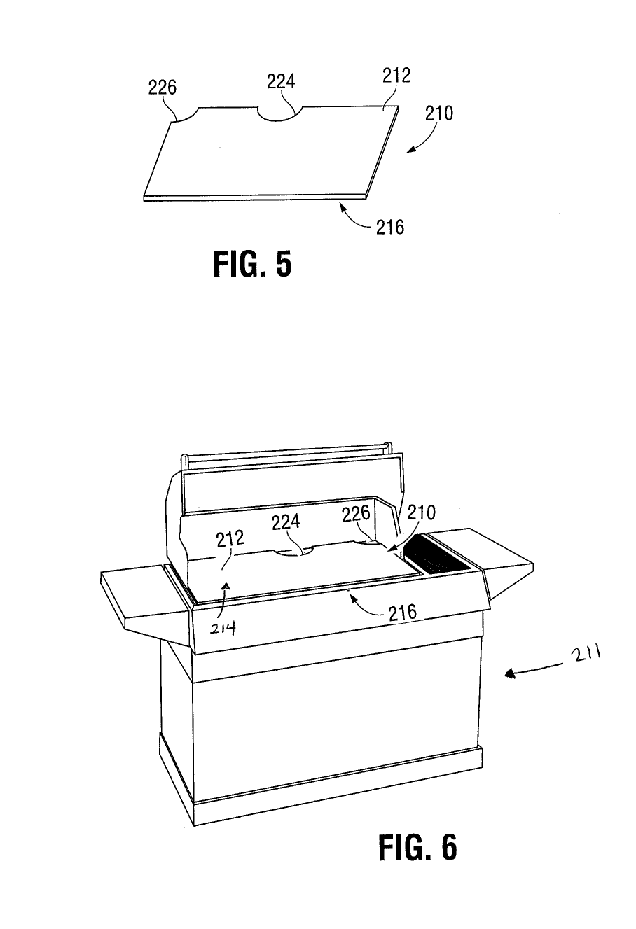

Thus far the discussion has involved a round grill. It should be understood that the present invention may be used with other shaped grills. For example most gas grills are rectangular in shape. Referring to FIGS. 5 and 6, a cooktop apparatus 210 for an exemplary rectangular gas grill 211 is shown. The cooktop apparatus 210 comprises a plate 212. The plate 212 defines a top surface 214 and a bottom 216. The plate 212 further defines an aperture, which in this embodiment is aperture 224 formed towards the rear of the plate away from the cook, and semicircular in shape. Alternatively, the aperture may be formed along the side or at a corner of the plate, such as aperture 226.

While a presently preferred embodiment of the present invention has been shown and described, it will be apparent that modifications may be made without departing from the scope of the invention as defined in the attached claims.

I claim:

1. A cooktop apparatus adapted to be mounted with a grill or firepit device, the apparatus comprising:
a generally planar plate defining a top surface and a bottom;
the top surface being a continuous surface and food-safe,
the bottom adapted to engage an upper portion of the grill or firepit such that the bottom is positioned above a heat source in the grill or firepit device; and
the plate further defining at least one aperture.

2. The cooktop apparatus of claim 1, wherein the plate defines a generally disc-shaped member.

3. The cooktop apparatus of claim 1, wherein the aperture is an interiorly formed interior aperture.

4. The cooktop apparatus of claim 4, wherein the interior aperture is centrally located and defines a generally circular outline.

5. The cooktop apparatus of claim 1 further including at least one handle connected to the plate.

6. The cooktop apparatus of claim 5, wherein the at least one handle includes a heat-insulated portion.

7. The cooktop apparatus of claim 5, wherein handle is detachable.

8. The cooktop apparatus of claim 1, wherein the bottom comprises a lip adapted to engage a rim of the grill or firepit device.

9. The cooktop apparatus of claim 1, wherein the top surface defines a slope extending downward towards the at least one aperture.

10. The cooktop apparatus of claim 1, wherein the bottom is configured to engage with a plurality of grill or firepit brackets.

11. A griddle mountable with a grill or firepit device, the griddle comprising:
a generally planar metal plate,
the metal plate including a food-safe continuous top surface and a bottom;
the plate defining an aperture.

12. The griddle of claim 11, wherein the plate defines a generally disc-shaped periphery.

13. The griddle of claim 11 further including at least one handle secured with the plate.

14. The griddle of claim 11, wherein the bottom comprises a lip adapted to engage a rim of the grill or firepit device.

15. The griddle of claim 11, wherein the top surface defines a slope extending downward towards the aperture.

16. The griddle of claim 11, wherein the aperture is formed in the interior of the plate.

17. A griddle component adapted to be engaged with a grill or firepit, the griddle comprising:
a generally planar metal plate defining a substantially circular periphery and further defining a substantially centrally located aperture, the aperture defining a substantially circular outline;
a substantially smooth continuous top surface; and
a bottom surface adapted to engage an upper portion of the grill or firepit.
